(19) United States
(12) Patent Application Publication
(10) Pub. No.: US 2008/0106410 A1
(43) Pub. Date: May 8, 2008

(54) SYSTEM, METHOD AND PROGRAM FOR MONITORING RFID TAGS IN A LIBRARY

(75) Inventor: Leonard G. Jesionowski, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/556,263

(22) Filed: Nov. 3, 2006

(51) Int. Cl. G08B 29/00

(52) U.S. Cl. 340/572.1

(57) ABSTRACT

Disclosed herein is a system that relates to a tape library radio frequency identification (RFID) tag testing system. The system comprising, an automated tape library with a plurality of tapes in the library. A RFID tag attached to each of the plurality of tapes. A tag health monitoring device able to read the quality of a return signal from the plurality of RFID tags, and a processor for analyzing and reporting on the quality data gathered.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

Data tape libraries with automated loading, unloading and transporting of the tape cartridges is common in industry. Such libraries use robots, or robotic arms, to maneuver the tapes from shelves to drives and back as needed. Keeping track of tapes through their travel can be cumbersome, and some libraries are looking to radio frequency identification (RFID) tags as a way to simplify and automate the tracking process. RFID tags allow for wireless identification of whatever the tag is attached to, including tape cartridges.

An RFID tag typically includes a memory, an RF transmitter, an RF receiver, an antenna, and logic for controlling the various components of the memory device. The antenna is generally formed on a flexible substrate, while analog RF circuits and an integrated circuit (IC) carried by the substrate are coupled to the antenna. RFID tags may also include a number of discrete components, such as capacitor, transistors, and diodes. A number of factors may affect the performance of an RFID tag and some of these factors can cause a reduction in performance over time. For example, an RFID tag may over time produce a different response signal in response to the same energization signal due to degradation of the antenna due to corrosion or physical damage. Depending upon the severity of the degradation of the response signal the RFID may become unreadable.

The RFID tape tracking system is only functional as long as the RFID tags themselves are operational. A tag that becomes nonfunctional can therefore create difficulties in tracking tapes in an automated tape library system that has come to depend upon them. It would, therefore, be desirable if a system could automatically detect and monitor the health of the RFID tags.

### BRIEF DESCRIPTION OF THE INVENTION

Disclosed herein is a system that relates to a tape library radio frequency identification (RFID) tag testing system. The system comprising, an automated tape library with a plurality of tapes in the library. A RFID tag attached to each of the plurality of tapes. A tag health monitoring device able to read the quality of a return signal from the plurality of RFID tags, and a processor for analyzing and reporting on the quality data gathered.

Further disclosed herein is a method that relates to verifying RFID tags on data storage media in an automated data storage media library. The method comprising, attaching RFID tags to data storage media in an automated data storage media library. Positioning a RFID tag reader at a structure in the data storage media library. Energizing one of the RFID tags with the RFID tag reader in response to the RFID tag being in a known location relative to the RFID tag reader. Receiving a return signal from the RFID tag with the tag reader, quantifying a quality of the received return signal, and recording the quality of the received return signal.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution, which monitors the return signal quality from RFID tags and alerts an operator when preset quality limits are breached.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a top view of an automated data storage media library with an automated RFID tag evaluation system disclosed herein.

The detailed description explains the preferred embodiments of the invention, together with advantages and features, by way of example with reference to the drawings.

### DETAILED DESCRIPTION OF THE INVENTION

A detailed description of several embodiments of the disclosed apparatus and method are presented herein by way of exemplification and not limitation with reference to the Figures.

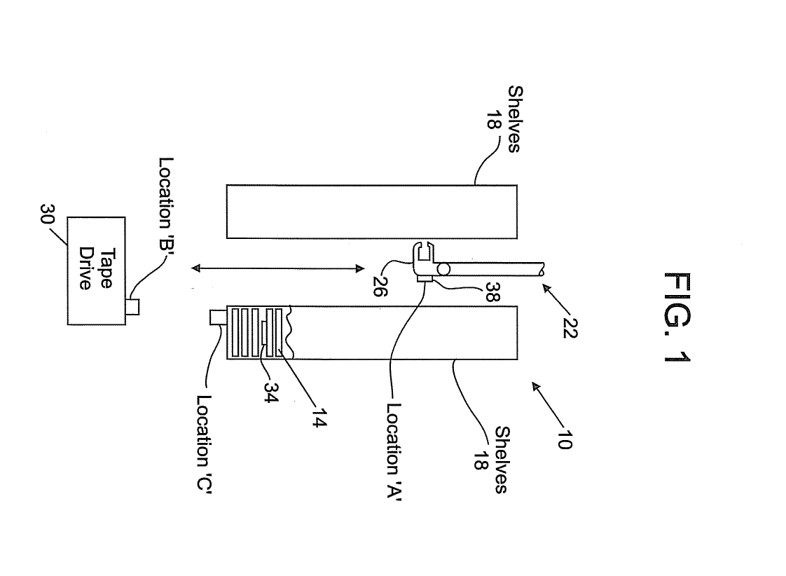

Turning now to the drawings in greater detail, it will be seen that in FIG. 1 there is an embodiment of an automated data storage media library depicted herein as a data tape library as shown generally at 10. A plurality of data storage media disclosed herein as data tapes 14 are stored in data storage media receptacles disclosed herein as shelves 18 of the library 10. When data stored on a particular tape 14 is required a robot 22, with a gripper 26, is computer controlled by server motors, hydraulic actuators, pneumatic actuators or the like (not shown) to remove the specific tape 14 from the shelf 18. The robot 22 transports the tape 14 to a data storage media drive capable of reading from and writing to the data storage media disclosed herein as an input/output (I/O) tape drive 30. The robot 22 loads the tape 14 into the tape drive 30 where data is retrieved from and/or written to the tape 14. When reading from and writing to the tape 14 is completed the robot 22 unloads the tape 14 from the drive 30 and returns it to the shelf 18. It should be understood that the term robot used herein is meant to include any automated means of transporting the tapes 14 between the shelves 18 and the drive 30.

For purposes of identification, each tape 14 has a unique serial number assigned thereto. By applying a radio frequency identification or RFID tag 34 to each tape 14 with the tape's serial number embedded therein, each tape 14 can be uniquely identified by reading the RFID tag 34 applied thereon. Reading of the RFID tag 34 can be performed easily and wirelessly with a RFID tag reader 38 positioned within an operational distance of the particular RFID system being employed.

Reading the RFID tag 34 consists of energizing the RFID tag 34 with electromagnetic or radio frequency (RF) energy provided by the RFID tag reader 38, and then receiving a response from the RFID tag 34. The response or return signal, in the form of RF transmitted energy includes, among other things, the serial number of the tape 14 thereby permitting identification of the tape 14. As discussed above the operational performances of the RFID tag 34 can vary over the life of the RFID tag 34 for a variety of reasons, the specifics of which are not necessary for the understanding of embodiments disclosed herein and therefore are not elaborated upon herein. Such performance variations can include a degradation in the quality of the response from the tag 34 in such things as signal strength, frequency or signal to noise ratio, for example. These degradations can happen quickly or slowly over time depending upon the particular cause for the degradation.

The RFID tag reader 38 can be made to monitor quality of the return signal from a RFID tag 34, and can therefore be used to monitor the health of each of the RFID tags 34. In alternate embodiments of the invention, a device separate from the RFID tag reader 38 can be used to determine the health of the RFID tags. Since the quality of the return signal can be affected by such parameters as distance and orientation between the reader 38 and the tag 34 it may be desirable to repeatedly control the distance and orientation between the reader 38 and the tag 34. Based on the physical geometry of the library 10 and the shelves 18 it may not be possible to position the reader 38 in a fixed location within the library 10 and maintain a fixed distance and orientation between the reader 38 and the tag 34. It may therefore be desirable to position the reader 38 such that it is in a fixed distance and orientation to the tapes 14 only when the tapes 14 are in the process of being removed from, returned to, or transported between the shelves 18 and the tape drive 30. Several potential locations for the reader 38 are shown in FIG. 1, and a description of each location will now be had.

Locating the reader 38 anywhere on the robot 22 will be considered location ‘A’. For purposes of description herein location ‘A’ is on the gripper 26, of the robot 22. Location ‘A’ provides a known and fixed distance as well as orientation between the reader 38 and the tag 34 while the robot 22 is transporting the tape 14. Location ‘A’ also provides a duration of time, during the transporting of the tape 14 to or from the drive 30 for the return signal quality measurement to be performed. Location ‘A’ also provides a varying distance between the reader 38 and the tag 34 while the robot 22 is approaching the tag 34 prior to picking up the tape 14 and again after the robot 22 has released the tape 14 and is moving away from the tape 14. It should also be noted that with the reader 38 at location ‘A’, any tag 34 on any tape 14 within the library could be read regardless of whether the particular tag 34 being read is on a tape 14 that is being transported or not. A second potential location for the reader 38 is location ‘B’, which is on or near the tape drive 30. Location ‘B’ also provides a repeatable, known fixed distance and orientation between the reader 38 and the tag 34 while the tape 14 is in the tape drive 38. Location ‘B’ provides a duration of time during the reading from and writing to the tape 14 for the return signal quality measurement to be performed. A third potential location is location ‘C’ in a fixed position in the library 10, for example, on the shelf 18.

Location ‘C.’, however, depending upon the transportation parameters of the robot 22, may not have a fixed distance or orientation between the reader 38 and the tag 34. Depending upon the RFID system used, however, and the associated time needed to measure the quality of the returned signal, location ‘C’ may be adequate. For robots 22 with a constant speed and path between the shelves 18 and the tape drive 30, location ‘C’ may provide a controlled, yet constantly changing, distance and orientation between the reader 38 and the tag 34 that is consistent for every tape 14 as it is transported between the shelves 18 and the tape drive 30. As such, as long as the RFID system is able to take readings during this transient condition, location ‘C’ may be an acceptable locational option.

Taking quality measurement readings during the transient conditions just described may be desirable to evaluate the susceptibility of the tag 34 to specific transient conditions. All three locations; ‘A’, ‘B’, and ‘C’ have the ability to measure the quality or the returned signal during transient conditions since the measurements can be made while the tape 34 is in motion relative to the position of the reader 38, whether it is at location ‘A’, ‘B’ or ‘C’.

Regardless of the location of the reader 38 the processing of the quality data gather can be handled in the same manner. For example, a computer processor could display the data immediately to an operator, or could store the data in a database for later retrieval and report generation, for example. Threshold levels of the various quality levels could be established such that alerts are generated only when a level is breached, for example, which could then flag the particular tape 14 for replacement of the tag 34 fixed thereto.

As described above, embodiments may be in the form of computer-implemented processes and apparatuses for practicing those processes. In exemplary embodiments, the invention is embodied in computer program code. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. The technical effect of the executable instructions is to convey quantified qualities of return signals from RFID tags.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A tape library radio frequency identification (RFID) tag testing system, comprising:
an automated tape library;
a plurality of tapes in the library;
a RFID tag attached to each of the plurality of tapes;
a tag health monitoring device able to read the quality of a return signal from the plurality of RFID tags; and
a processor for analyzing and reporting on the quality data gathered.

2. The RFID tag testing system of claim 1, wherein the tape health monitoring device is an RFID tag reader.

3. The RFID tag testing system of claim 1, further comprising:
a robot at the library capable of transporting the tapes within the automated library and the health monitoring device is attached to the robot.

4. The RFID tag testing system of claim 1, further comprising:
a tape drive at the library capable of reading from the tape and writing to the tape and the health monitoring device is attached to the tape drive.

5. The RFID tag testing system of claim 1, wherein the quality of the return signal determined by the RFID tag reader is of signal strength, signal frequency or signal to noise ratio.

6. A method of verifying RFID tags on data storage media in an automated data storage media library, the method comprising:
attaching RFID tags to data storage media in an automated data storage media library;
positioning a RFID tag reader at a structure in the data storage media library;
energizing one of the RFID tags with the RFID tag reader in response to the RFID tag being in a known location relative to the RFID tag reader;
receiving a return signal from the RFID tag with the tag reader;
quantifying a quality of the received return signal; and
recording the quality of the received return signal in a database.

7. The method of claim 6, further comprising:
comparing the quantified quality of the received return signal to at least one preset limit.

8. The method of claim 6, further comprising:
communicating to an operator when the quantified quality of the received return signal breaches at least one of the preset limits.

9. The method of claim 6, wherein the quantified quality of the received return signal is signal strength of the received return signal.

10. The method of claim 6, wherein the quantified quality of the received return signal is frequency of the received return signal.

11. The method of claim 6, wherein the quantified quality of the received return signal is signal to noise ratio of the received return signal.

12. A computer program product for providing RFID tag quality data in a computer environment, the computer program product comprising a storage medium readable by a processing circuit and storing instructions for execution by the processing circuit for facilitating a method comprising:
transmitting a RF signal with a RFID tag reader;
receiving a return signal from a RFID tag;
quantifying qualities of the received signal;
recording the quantified qualities of the received return signal in a database; and
outputting the quantified qualities to an operator.

13. The computer program product of claim 12, further comprising:
comparing the quantified qualities to preset thresholds.
